(19) United States
(12) Patent Application Publication
(10) Pub. No.: US 2015/0269133 A1
(43) Pub. Date: Sep. 24, 2015

(54) ELECTRONIC BOOK READING INCORPORATING ADDED ENVIRONMENTAL FEEL FACTORS

(71) Applicant: International Business Machines Corporation, Armonk, NY (US)

(72) Inventors: Lydia M. Do, Raleigh, NC (US); Pamela A. Nesbitt, Ridgefield, CT (US); Sandeep R. Patil, Pune (IN); Riyazahamad M. Shiraguppi, Pune (IN)

(73) Assignee: International Business Machines Corporation, Armonk, NY (US)

(21) Appl. No.: 14/219,325

(22) Filed: Mar. 19, 2014

(51) Int. Cl. G06F 17/24; G06F 3/01; H04N 7/18

(52) U.S. Cl. CPC G06F 17/241; H04N 7/183; G06F 3/013

(57) ABSTRACT

A method of augmenting an electronic book (e-book) reading experience on a portable electronic device, and a system to augment are described. The method includes determining, using a processor, a current page and line of the e-book being read. The method also includes obtaining context information associated with the current page and line, the context information including one or more of a genre of the e-book, a type of scene, and one or more objects involved in the scene, and determining features used in the augmenting based on associating the context information with the features, the features including one or more of a text color, font type, font size, music, image, and animation.

### BACKGROUND

The present invention relates to a portable electronic device, and more specifically, to the addition of environmental feel factors during reading on a portable electronic device.

Electronic books or e-books are publications provided to a reader in digital form for viewing of both text and illustrations on a display device of a portable electronic device. Some portable electronic devices are designed predominantly for reading. These devices typically include features such as improved readability in bright sunlight and longer battery life. Other portable electronic devices (e.g., tablet computers) serve many computing and communication functions in addition to an e-book reader function. Both types of portable electronic devices may include wireless communication features.

### SUMMARY

According to one embodiment of the present invention, a method of augmenting an electronic book (e-book) reading experience on a portable electronic device includes determining, using a processor, a current page and line of the e-book being read; obtaining context information associated with the current page and line, the context information including one or more of a genre of the e-book, a type of scene, and one or more objects involved in the scene; and determining features used in the augmenting based on associating the context information with the features, the features including one or more of a text color, font type, font size, music, image, and animation.

According to another embodiment of the invention, a system to augment an electronic book (e-book) reading experience on a portable electronic device includes a camera configured to determine an eye-line of a user of the portable electronic device; and a processor configured to determine a current page and line of the e-book being read based on the eye-line, obtain context information based on the current page and line, and associate the context information with features used to augment the reading experience, the features including one or more of a text color, font type, font size, music, image, and animation.

According to yet another embodiment of the invention, a computer program product stores instructions which, when executed by a processor, cause the processor to implement a method of augmenting an electronic book (e-book) reading experience on a portable electronic device. The method includes determining a current page and line of the e-book being read; obtaining context information associated with the current page and line, the context information including one or more of a genre of the e-book, a type of scene, and one or more objects involved in the scene; and determining features used in the augmenting based on associating the context information with the features, the features including one or more of a text color, font type, font size, music, image, and animation.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a schematic diagram of an exemplary portable electronic device according to embodiments of the invention;

FIG. 2 is a process flow diagram of a method of augmenting the e-book reading experience according to embodiments of the invention;

FIG. 3 is a process flow diagram of a method of performing intelligent mood analysis according to an exemplary embodiment;

FIG. 4 depicts an exemplary metadata table according to an embodiment of the invention; and

FIG. 5 illustrates exemplary look-up tables to determine features corresponding with context information according to embodiments of the invention.

### DETAILED DESCRIPTION

As noted above, portable electronic devices that are specially designed as e-book readers or that serve multiple functions may be used to read e-books. When reading an e-book, the experience provided by these portable electronic devices is the same static experience as a physical book. That is, nothing additional to the text or illustrations of the e-book is displayed. Embodiments of the systems and methods described herein relate to augmenting the e-book reading experience with audio and visual enhancements. The enhancements are dynamically added based on the particular content and context of the e-book being read. The enhancements take advantage of the processing and communication capabilities of the portable electronic devices being used as e-book readers.

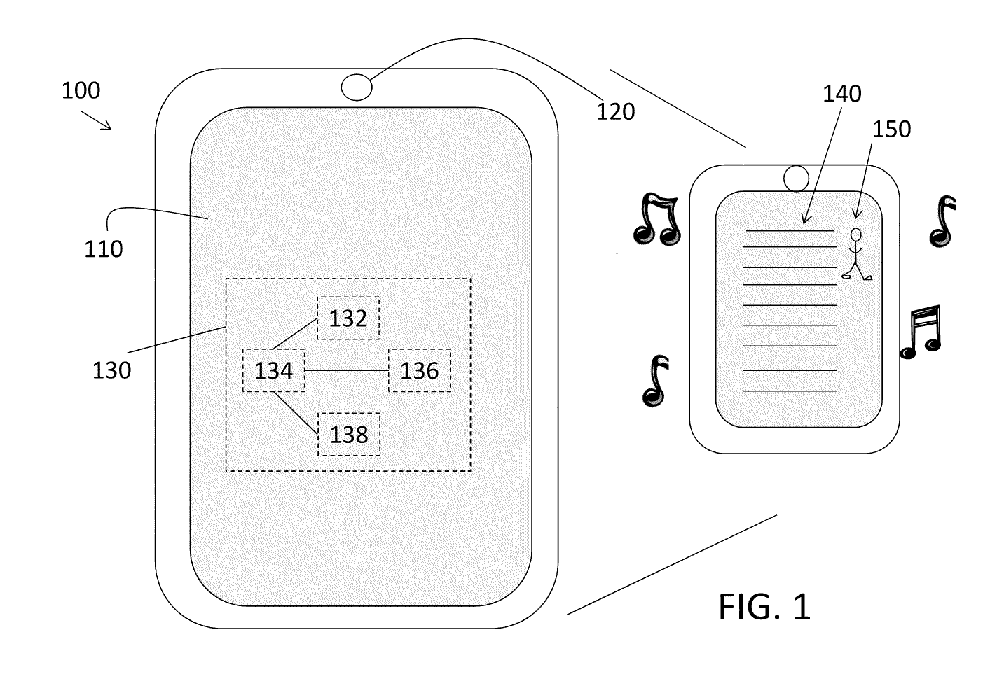

FIG. 1 is a schematic diagram of an exemplary portable electronic device 100 according to embodiments of the invention. The portable electronic device 100 includes a screen 110 on which the e-book is displayed, a camera 120, and components 130 that control the functionality of the portable electronic device 100. The components 130 may include an input interface 132, one or more processors 134, one or more memory devices 136, and an output interface 138. The input interface 132 receives camera input and may receive user input in the form of touchscreen input or a keypad or keyboard, for example. The output interface 138 outputs both audio and visual output and may additionally output wireless communication signals. As FIG. 1 illustrates, according to embodiments of the invention detailed below, the e-book text 140 displayed on the screen 110 of the portable electronic device 100 may be augmented with music and other features (e.g., animation 150).

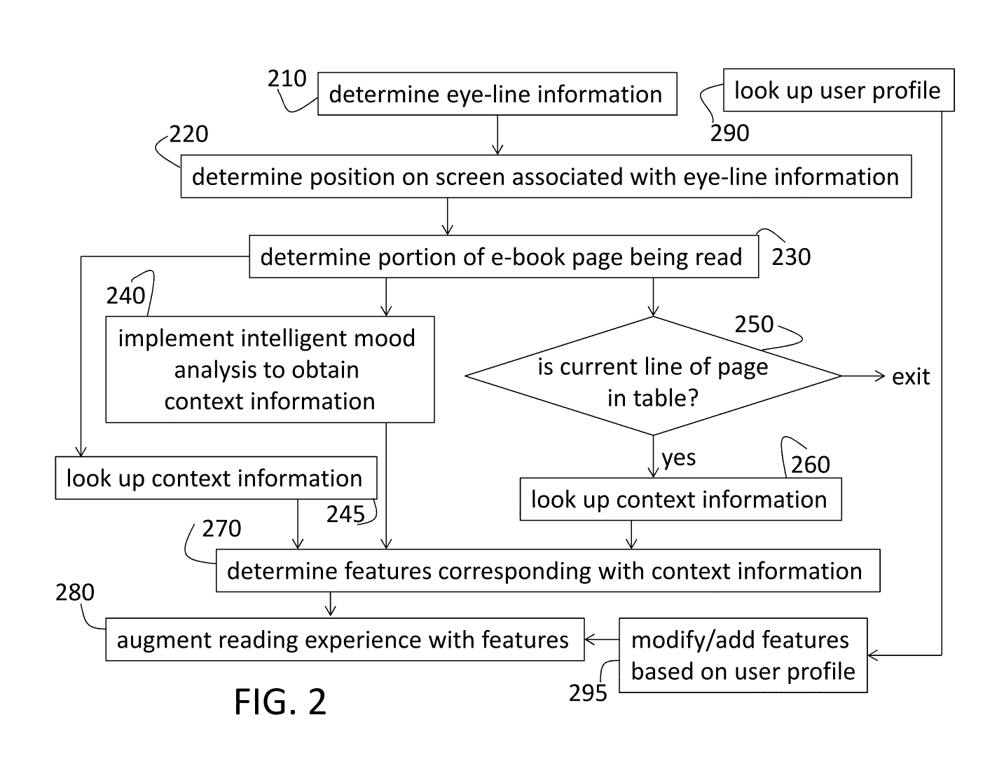

FIG. 2 is a process flow diagram of a method of augmenting the e-book reading experience according to embodiments of the invention. At block 210, determining eye-line information includes using the camera 120 of the portable electronic device 100. The camera determines the eye-line (eye location) of the user of the e-book functionality of the portable electronic device 100 based on known (eyeball) image recognition technology, for example. At block 220, determining the position on the screen 110 associated with the eye-line information includes calculating the location on the screen 110 corresponding with the position of the eyeball (e-book user's eye-line). This is also based on known techniques. Knowing the position on the screen 110 associated with the user's eye-line information facilitates determining the portion of the e-book page being read at block 230. Specifically, the line of text 140 of the current page of the e-book being viewed on the screen 110 is determined. From the portion (line) of the current page of the e-book being viewed, context information relating to genre of the e-book, type of scene currently being read, and objects involved in the currently read portion of the e-book, for example, may be determined according to different embodiments detailed below. While the genre of the e-book, type of scene, and objects involved are discussed as exemplary items providing context information, the examples are not intended to be limiting. The type of scene itself may include varied information such as a location or setting of the scene, mood, and characters involved, as just a few examples.

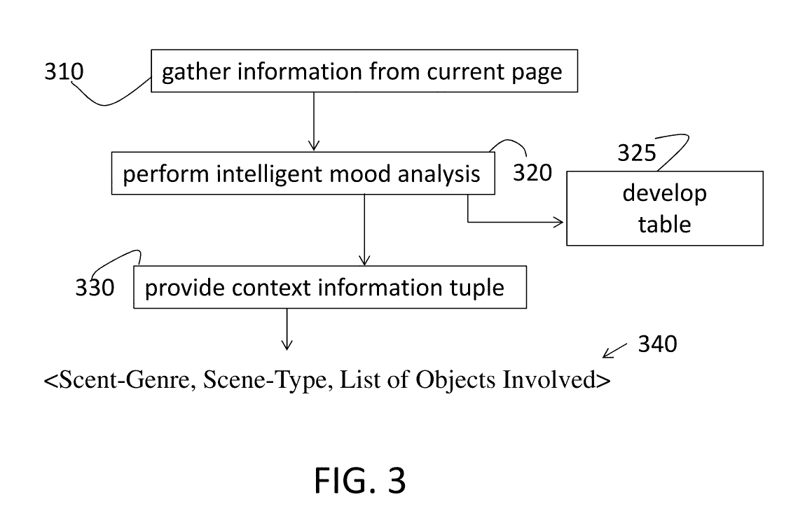

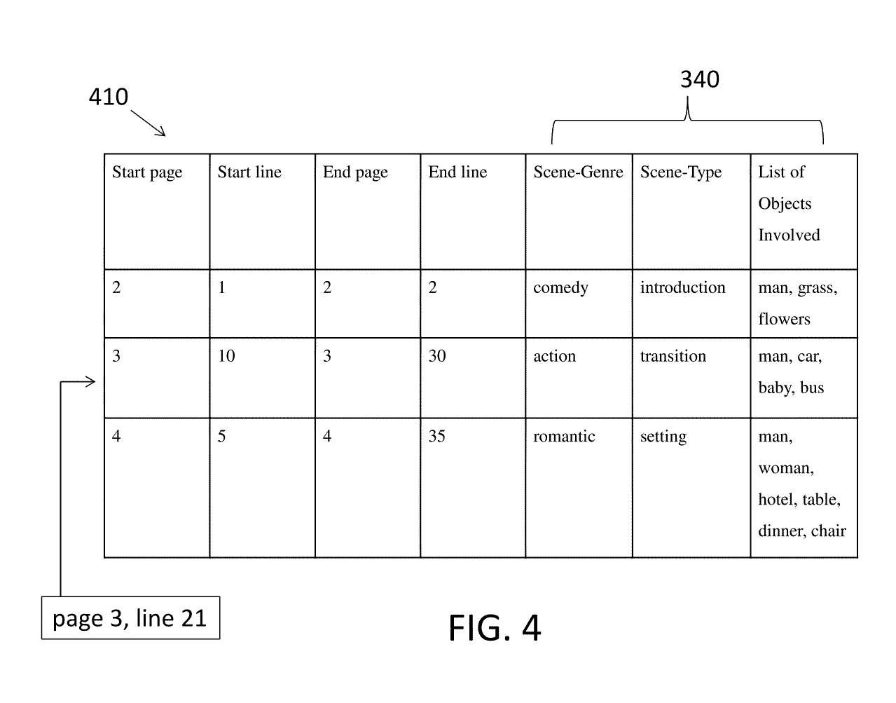

At block 240, implementing an intelligent mood analysis to obtain context information includes implementing a known processing technique with a processor 134 of the portable electronic device 100 or a processor accessible to the portable electronic device 100 on a cloud computing network, for example. FIG. 3 is a process flow diagram of a method of performing intelligent mood analysis according to an exemplary embodiment. At block 310, gathering information from the current page being read includes inputting the text 140, any embedded tags, and sentence arrangements, for example. Information beyond the current line, such as the paragraph or page, may be needed. At block 320, performing intelligent mood analysis may use lexical analysis and other known techniques in what is often referred to as sentiment analysis. The intelligent mood analysis results in context information for the current page and line of the e-book. At block 325, this context information may be used for developing a table. The table may be similar to the table 410 (FIG. 4) that may be pre-associated with the e-book according to alternate embodiments of the invention, discussed below. Once the table is generated through the intelligent mood analysis during a reading of the e-book, the table may be used for looking up context information (block 245, FIG. 2) in lieu of performing the intelligent mood analysis again during subsequent readings of the e-book. Returning to the process shown at FIG. 3, at block 330, providing a context information tuple 340 is based on the context information resulting from the intelligent mood analysis. An exemplary context information tuple 340 may be in the form <Scene-Genre, Scene-Type, List of Objects Involved>, as shown in FIG. 3. As noted above, the context information is not limited by the exemplary items shown in the context information tuple 340.

Returning to the process flow shown in FIG. 2, at block 250, the processor 134 determines whether the line of the page currently being read is included in a table 410 (FIG. 4). The table 410 includes metadata associated with the e-book that may have been provided by the e-book editor, for example. That is, the table 410 entries may be manually entered and associated with the e-book. The table 410 may be distributed with the e-book to individual users (stored in a memory device 136 of the portable electronic device 100) or the table 410 may be stored within a cloud computing network and accessible to the portable electronic device 100. FIG. 4 depicts an exemplary metadata table 410 according to an embodiment of the invention. Each entry (row, as shown in FIG. 4) of the table 410 specifies a range of the e-book (start page, start line, end page, end line) and context information corresponding to the range. For example, if the processor 134 determines that page 3, line 21 of the e-book is currently being read (at block 230), then, at block 250, the processor 134 would determine that the current line of the page is included in the table 410. At block 260, looking up the context information includes outputting a context information tuple 340 that corresponds with the table entry 410. In the exemplary case of table 410 shown in FIG. 4, outputting a context information tuple 340 corresponding with page 3, line 21 includes outputting <action, transition, man, car, baby, bus>.

The process at block 240 may be implemented additionally or alternatively with the processes at blocks 250 and 260. That is, based on a user selection or the availability of metadata for a given e-book, the processes at blocks 250 and 260 may be implemented first, for example. The process at block 240 may be performed only when a table 410 entry is not found. Alternatively, only one of the methods of obtaining a context information tuple 340 (block 240 or blocks 250 and 260) may be implemented. Once a context information tuple 340 is obtained, determining features corresponding with the context information, at block 270, may be implemented as a series of look-up tables or by known processes, as discussed below.

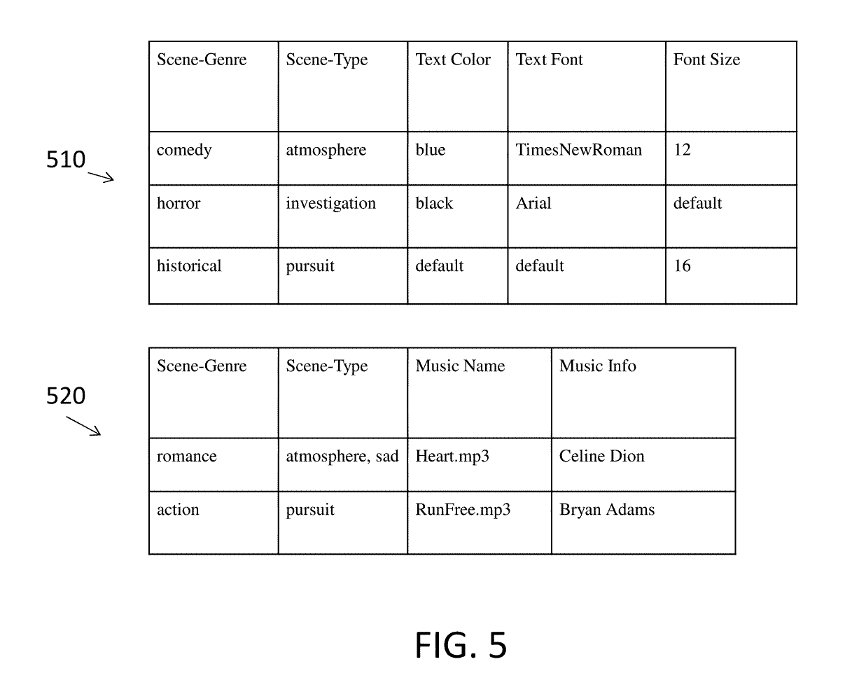

FIG. 5 illustrates an exemplary look-up table 510 and aspects of an exemplary process 520 to determine features corresponding with context information according to embodiments of the invention. Exemplary features include music, text color, font type, font size, images, and animation for the sake of discussion, but the features are not limited by these examples. One of more features may involve a different look-up table as shown in FIG. 5. In the example shown in FIG. 5, table 510 facilitates a direct look-up of features related to the text (text color, text font, font size) corresponding to context information. Table 520 illustrates information used in a known process to map information such as Scene-Genre and Scene-Type to Music Type and Sub-type.

Returning to the process at FIG. 2, once the feature or features corresponding with the context information associated with the portion of the e-book being read are determined, augmenting the reading experience with the features, at block 280, may include incorporating features (e.g., font features and animation or images) into the display on the screen 110 and playing music. In additional embodiments, the reading experience may be augmented based on a user's profile, as well. At block 290, looking up a user profile includes looking up information about the user and about the user's preferences. For example, looking up the user profile may include determining that the user is a female with a preference for the color yellow. Based on this information, modifying or adding features based on the user profile, at block 295, may include modifying the background color for a happy scene to be yellow, for example. That is, when the context information (obtained at block 240 or 260) indicates the Scene-Type as happy, the corresponding background color (obtained at block 270) may be sky blue. This color may be modified, based on the user's indicated preference for the color yellow (obtained at block 290), to augment the reading experience (at block 280) accordingly. The user's profile may additionally include age or geography (current location) information for the user that additionally affects preferences.

The process flow shown in FIG. 2 may be repeated periodically. The period may be based on the speed at which the e-book is being read by the user, for example. The speed of reading may be determined by the frequency at which the pages are advanced. Features such as images and animations may be specified as being in the background or foreground, and their location within the screen 110 may be individually specified or areas of the screen 110 may generally be designated for those features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method of augmenting an electronic book (e-book) reading experience on a portable electronic device, the method comprising:
determining, using a processor, a current page and line of the e-book being read;
obtaining context information associated with the current page and line, the context information including one or more of a genre of the e-book, a type of scene, and one or more objects involved in the scene; and
determining features used in the augmenting based on associating the context information with the features, the features including one or more of a text color, font type, font size, music, image, and animation.

2. The method according to claim 1, wherein the determining the current page and line being read includes determining a position on a screen of the portable electronic device currently being viewed and associating the position on the screen with the line based on the page being displayed on the screen.

3. The method according to claim 2, wherein the determining the position on the screen currently being viewed includes using a camera coupled to the portable electronic device to determine an eye-line of a user of the portable electronic device and calculating the position based on the eye-line.

4. The method according to claim 1, wherein the obtaining the context information includes performing mood analysis on text at the current page and line.

5. The method according to claim 4, wherein the performing the mood analysis results in obtaining a context information tuple associated with the current page and line, the context information tuple including the one or more of the genre of the e-book, the type of scene, and the one or more objects involved in the scene.

6. The method according to claim 1, wherein the obtaining the context information includes using metadata stored in association with the e-book to obtain a context information tuple associated with the current page and line, the context information tuple including the one or more of the genre of the e-book, the type of scene, and the one or more objects involved in the scene.

7. The method according to claim 1, wherein the associating the context information with the features includes using one or more look-up tables.

8. The method according to claim 1, further comprising further augmenting the e-book reading experience based on a user profile, wherein the further augmenting includes modifying the features or adding additional features.

9. A system to augment an electronic book (e-book) reading experience on a portable electronic device, the system comprising:
a camera configured to determine an eye-line of a user of the portable electronic device; and
a processor configured to determine a current page and line of the e-book being read based on the eye-line, obtain context information based on the current page and line, and associate the context information with features used to augment the reading experience, the features including one or more of a text color, font type, font size, music, image, and animation.

10. The system according to claim 9, wherein the processor determines the current page and line of the e-book based on calculating a position on a screen of the portable electronic device currently being viewed based on the eye-line of the user and associating the position on the screen with the line based on the page being displayed.

11. The system according to claim 9, wherein the processor obtains the context information based on performing mood analysis on text at the current page and line.

12. The system according to claim 11, wherein the processor obtains a context information tuple associated with the current page and line based on performing the mood analysis, the context information tuple including the one or more of the genre of the e-book, the type of scene, and the one or more objects involved in the scene.

13. The system according to claim 9, wherein the processor obtains the context information based on metadata stored in association with the e-book and obtains a context information tuple associated with the current page and line, the context information tuple including the one or more of the genre of the e-book, the type of scene, and the one or more objects involved in the scene.

14. The system according to claim 9, wherein the processor associates the context information with the features based on accessing one or more look-up tables.

15. The system according to claim 9, wherein the processor is further configured to modify the features or add additional features to augment the e-book reading experience based on information in a user profile.

16. A computer program product storing instructions which, when executed by a processor, cause the processor to implement a method of augmenting an electronic book (e-book) reading experience on a portable electronic device, the method comprising:
determining a current page and line of the e-book being read;
obtaining context information associated with the current page and line, the context information including one or more of a genre of the e-book, a type of scene, and one or more objects involved in the scene; and
determining features used in the augmenting based on associating the context information with the features, the features including one or more of a text color, font type, font size, music, image, and animation.

17. The computer program product according to claim 16, wherein the determining the current page and line includes obtaining, from a camera coupled to the portable electronic device, an eye-line of a user of the portable electronic device, calculating a position on a screen of the portable electronic device currently being viewed based on the eye-line, and associating the position on the screen with the line based on the page being displayed on the screen.

18. The computer program product according to claim 16, wherein the obtaining the context information includes performing mood analysis on text at the current page and line to obtain a context information tuple associated with the current page and line, the context information tuple including the one or more of the genre of the e-book, the type of scene, and the one or more objects involved in the scene.

19. The computer program product according to claim 16, wherein the obtaining the context information includes using metadata stored in association with the e-book to obtain a context information tuple associated with the current page and line, the context information tuple including the one or more of the genre of the e-book, the type of scene, and the one or more objects involved in the scene.

20. The computer program product according to claim 16, further comprising further augmenting the e-book reading experience based on a user profile, wherein the further augmenting includes modifying the features or adding additional features.
